(19) United States
(12) Patent Application Publication
(10) Pub. No.: US 2013/0234897 A1
(43) Pub. Date: Sep. 12, 2013

(54) MOBILE TERMINAL APPARATUS AND METHOD FOR PERFORMING WIRELESS COMMUNICATION USING AN INDIRECT FEEDING ANTENNA

(71) Applicant: PANTECH CO., LTD., Seoul (KR)

(72) Inventor: Hee-June YOON, Seoul (KR)

(73) Assignee: PANTECH CO., LTD., Seoul (KR)

(21) Appl. No.: 13/785,244

(22) Filed: Mar. 5, 2013

(30) Foreign Application Priority Data
Mar. 7, 2012 (KR) 10-2012-0023172

(51) Int. Cl. H01Q 19/00

(52) U.S. Cl. CPC H01Q 19/00
USPC 343/700 MS; 29/600

(57) ABSTRACT

A mobile terminal apparatus and method for performing wireless communication, including a main antenna to transmit or receive signals at one or more first frequency bands, a sub antenna to transmit or receive signals at least at one second frequency band, and a feeding pad connected to the main antenna to directly supply power or signals to the main antenna to transmit or receive signals at the one or more first frequency bands, the feeding pad being spaced apart from or disposed within a reference proximity to and electrically coupled to the sub antenna to indirectly supply power or signals to the sub antenna to transmit or receive signals in the at least one second frequency band.

### CROSS-REFERENCE TO RELATED APPLICATION

This application claims the benefit under 35 U.S.C. §119(a) of Korean Patent Application No. 10-2012-0023172, filed on Mar. 7, 2012, the entire disclosure of which is incorporated herein by reference for all purposes.

### BACKGROUND

1. Field

Exemplary embodiments relate to mobile terminal apparatuses and methods for performing wireless communication using an indirect feeding antenna to additionally support a desired frequency band.

2. Discussion of the Background

Development of antenna technologies has contributed to development of small-size, slim mobile communication terminals.

Known first-generation mobile communication terminals may have stud type antennas that protrude out of their housings, the stud type antennas may be easily broken and limiting the design of the terminal.

However, recently, an antenna, sometimes called an “intenna,” that is installed in a housing to be invisible externally has been introduced and popularized.

However, such “intenna” also needs to meet requirements of excellent radiation characteristics and a wide bandwidth while having a small size to be installed in a small-sized, slim mobile communication terminal. Particularly, a space for an antenna gets more limited as mobile terminals get slimmer and smaller and, accordingly, the importance of designing an antenna having excellent characteristics without increasing its size becomes greater. Furthermore, recently developed terminals may need to cover two or more frequency bands.

For example, in the case of a mobile communication terminal based on the Long Term Evolution (LTE) technology according to the 3GPP specification, which is a representative 4G mobile communication technology, the mobile communication terminal has to basically support frequency bands of 700 MHz through 960 MHz and 2.5 GHz through 2.7 GHz.

In order to support multiple bandwidths with a single antenna, a method of forming a plurality of patterns in a radiating element for transmission/reception to cause double resonance can be used. However, such method may have difficulty in acquiring a wide receiving bandwidth.

### SUMMARY

Exemplary embodiments of the present invention provide apparatuses and methods for performing wireless communication by a mobile terminal apparatus, such as handheld, portable or tablet computer or communication devices, with an indirect feeding sub antenna to support a desired frequency band, such as may be used for voice or data communications.

Additional features of the invention will be set forth in the description which follows, and in part will be apparent from the description, or may be learned by practice of the invention.

Exemplary embodiments of the invention provide a mobile terminal apparatus with an indirect feeding antenna, capable of supporting multiple frequency bands and a wide frequency band range by additionally supporting a desired second frequency band or bands, as well as a first frequency band or bands supported by a main antenna, by feeding a sub antenna indirectly through coupling with a feeding pad of the main antenna to produce an additional resonance when the main antenna produces a resonance.

Exemplary embodiments of the invention provide a mobile terminal apparatus with an indirect feeding antenna, of a multi-band antenna, by producing an additional resonance by a sub antenna without changing a resonance frequency band of a main antenna.

The following description also relates to a mobile terminal apparatus with an indirect feeding antenna, capable of providing a sub antenna without increasing the volume of the mobile terminal apparatus by forming the sub antenna in a space or area of the mobile terminal apparatus for a main antenna.

Exemplary embodiments of the invention provide a mobile terminal apparatus to perform wireless communication, including a main antenna to transmit or receive signals at one or more first frequency bands, a sub antenna to transmit or receive signals at least at one second frequency band, and a feeding pad connected to the main antenna to directly feed signals to the main antenna to transmit or receive signals at the one or more first frequency bands, the feeding pad being disposed within a reference proximity to and electrically coupled to the sub antenna to indirectly feed signals to the sub antenna to transmit or receive signals in the at least one second frequency band.

Exemplary embodiments of the invention further provide a method for performing wireless communication in a mobile terminal apparatus, including feeding signals at one or more first frequency bands directly by a feeding pad to a main antenna to transmit or receive signals at the one or more first frequency bands, and feeding signals at least at one second frequency band indirectly by the feeding pad to a sub antenna, by electrically coupling the feeding pad to the sub antenna disposed within a reference proximity to the feeding pad, to transmit or receive signals in the at least one second frequency band.

Exemplary embodiments of the invention additionally provide a method for performing wireless communication in a mobile terminal apparatus, including selectively feeding signals at one or more first frequency bands directly by a feeding pad to a main antenna to selectively transmit or receive signals at the one or more first frequency bands, and selectively feeding signals at least at one second frequency band indirectly by the feeding pad to a sub antenna, by electrically coupling the feeding pad to the sub antenna disposed within a reference proximity to the feeding pad, to selectively transmit or receive signals in the at least one second frequency band.

Other features and aspects of exemplary embodiments of the invention will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view of a mobile terminal apparatus with an indirect feeding antenna according to exemplary embodiments of the present invention.

FIG. 2 is a perspective view showing an arrangement structure of a main antenna and a sub antenna according to exemplary embodiments of the present invention.

FIG. 3 is a perspective view showing an arrangement structure of a main antenna, a sub antenna, and a circuit substrate according to exemplary embodiments of the present invention.

FIG. 4 is a perspective view showing an arrangement structure of a main antenna and a sub antenna according to exemplary embodiments of the present invention.

FIG. 5 is a perspective view showing the main antenna, the sub antenna, the circuit substrate, and an antenna carrier unit of FIG. 3 according to exemplary embodiments of the present invention.

FIG. 6 is a cross-section view showing the main antenna, the sub antenna, and the circuit substrate of FIG. 5 according to exemplary embodiments of the present invention.

FIG. 7 is a circuit diagram illustrating an example of a mobile terminal apparatus with an indirect feeding antenna according to exemplary embodiments of the present invention.

FIG. 8 is a graph showing a VSWR (Voltage Standing Wave Ratio) with respect to frequency of a main antenna that supports multiple bands when no sub antenna is provided as a comparison to exemplary embodiments of the present invention.

FIG. 9 is a graph showing a VSWR with respect to frequency when a sub antenna supporting a high frequency band is formed or disposed on a lower face of a circuit substrate through an indirect feeding method according to exemplary embodiments of the present invention.

FIG. 10 and FIG. 11 are graphs showing VSWRs with respect to frequency when a sub antenna supporting a low frequency band is formed or disposed on the lower surface of a circuit substrate through an indirect feeding method according to exemplary embodiments of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience, and should not be construed in a limiting sense.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Also, descriptions of well-known functions and constructions may be omitted for increased clarity and conciseness.

It will be understood that when an element is referred to as being “connected to” or “coupled to” another element, it may be directly connected or coupled to the other element or it may be indirectly connected or coupled to another element, or intervening elements may be present.

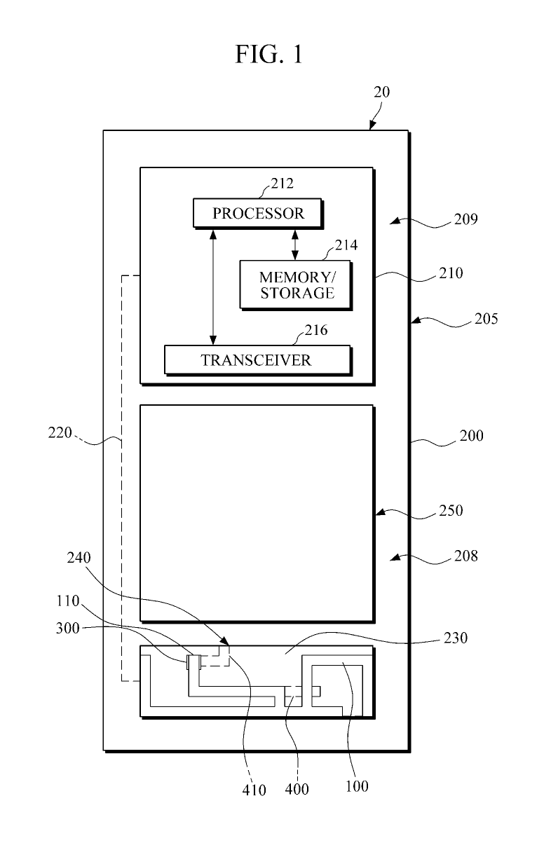

FIG. 1 is a plan view of a mobile terminal apparatus with an indirect feeding antenna according to exemplary embodiments of the present invention.

Referring to FIG. 1, the mobile terminal apparatus 20 with an indirect feeding antenna includes a main antenna 100 that receives or transmits electromagnetic waves or signals of the corresponding one or more first frequency bands, a circuit substrate 200 on which a circuit for processing signals received/transmitted through the main antenna 100 may be mounted, a feeding pad 300 that connects the main antenna 100 to the circuit substrate 200 directly and may be formed or disposed on the circuit substrate 200, and a sub antenna 400 spaced apart from or disposed within a reference proximity to the feeding pad 300 in such a way to face the feeding pad 300, the indirect feeding antenna or sub antenna 400 being indirectly connected by being electrically coupled to the feeding pad 300 for indirect feeding of power or signals to transmit or receive electromagnetic waves or signals at least at one desired second frequency band.

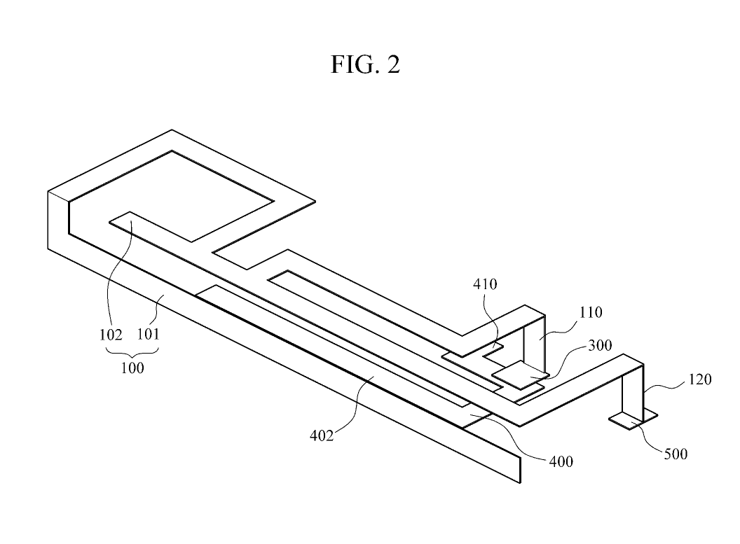

FIG. 2 is a perspective view showing an arrangement structure of the main antenna 100 and the sub antenna 400 according to exemplary embodiments of the present invention.

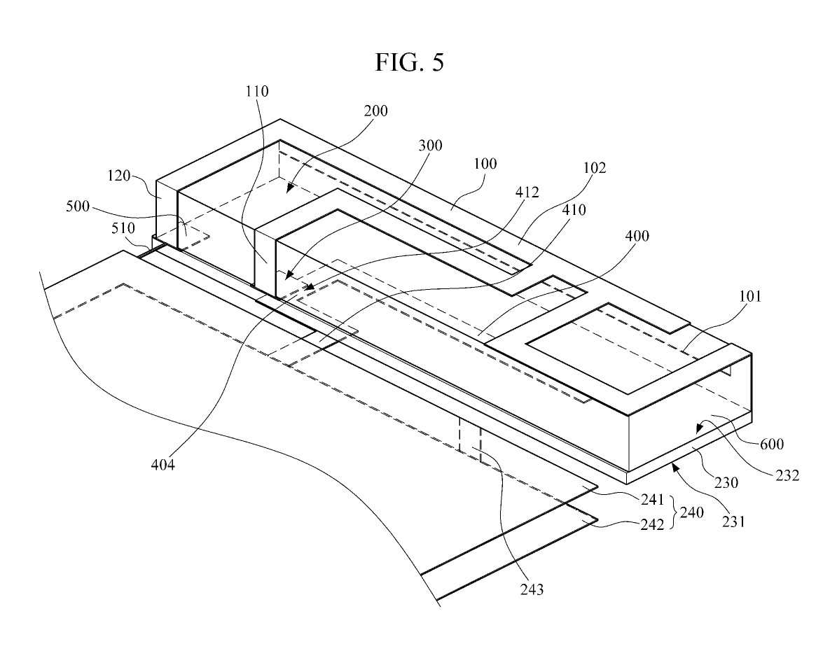

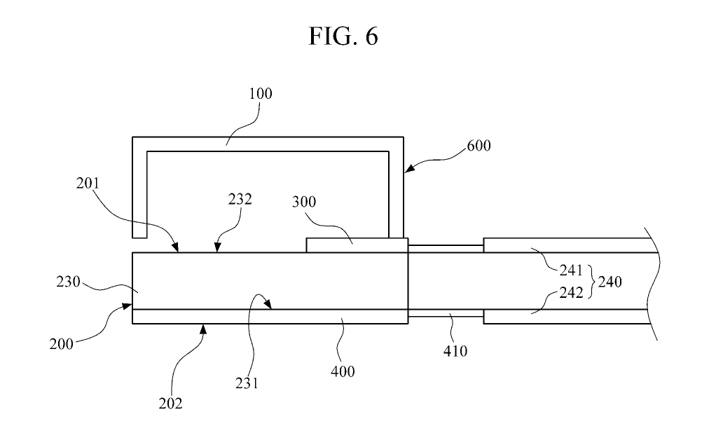

In FIG. 2 circuit substrate 200 is not illustrated for clarity, and the main antenna 100 may be an antenna which resonates in a single frequency band or in multiple frequency bands. If the main antenna 100 supports multiple frequency bands, a plurality of radiating patterns 101 and 102 may be formed or disposed each of which has a length of λ/4 with respect to the wavelength of the corresponding frequency band such that a resonance is caused in each frequency band. The radiating patterns 101 and 102 are used to receive and transmit RF signals, for example. That is, the radiating patterns 101 and 102 resonate in a predetermined resonance frequency band to receive and transmit electromagnetic waves. The radiating patterns 101 and 102 are arranged over the circuit substrate 200. Also, the radiating patterns 101 and 102 may be spaced apart from or disposed within a reference proximity to the circuit substrate 200 by a distance corresponding to the thickness of an antenna carrier unit 600 (See, FIG. 5 and FIG. 6, for example). The radiating patterns 101 and 102 each may have a structure with at least one bent portion. Here, each of the radiating patterns 101 and 102 may have a meander structure, a spiral structure, a step structure, a loop structure, etc., for example.

In order to enable the radiating patterns 101 and 102 to radiate the corresponding frequencies, respectively, the length of the radiating pattern 101 corresponding to a low frequency band may be formed or disposed to be longer than that of the radiating pattern 102 corresponding to a high frequency band, since the length of a radiating pattern is inverse-proportional to frequency magnitude and proportional to wavelength length. Also, the main antenna 100 includes a feeding line 110 connected to the circuit substrate 200 (See FIG. 1, for example) to feed the radiating patterns 101 and 102, and a ground line 120 for grounding the feeding line 110, wherein the feeding line 110 and the ground line 120 may be integrated into one body.

For example, the main antenna 100 may include a low-band radiating pattern 101 that supports a frequency band ranging from 700 MHz to 960 MHz (LTE, CELL, G850, G900), and a high-band radiating pattern 102 that supports a frequency band ranging from 1700 MHz to 2100 MHz (DCS1800/PCS1900/US PCS/WCDMA).

The circuit substrate 200 may be used to process signals received/transmitted through the main antenna 100, and may be a main printed circuit board (PCB) or a sub PCB, for example. The circuit substrate 200 also acts to support electronic components in the mobile terminal apparatus 20. That is, electronic components, such as, for example, a processor or controller 212, a memory or storage 216, a transceiver 216, and a battery or other power supply 250, etc., are packaged and supported on the circuit substrate 200. Also, the circuit substrate 200 may include a ground 240 for grounding the circuit substrate 200 to a board body of the circuit substrate 200. The various electronic components, structures, and arrangement of the circuit substrate 200 of the mobile terminal apparatus 20, such as illustrated in FIG. 1, are exemplary of any of various suitable arrangements, structures, components and configurations and, therefore, should not be construed in a limiting sense.

The processor or controller 212 may include any of various processors, computers or application specific integrated circuits (ASICs) for example, to implement various operations in performing wireless communication by an indirect feeding antenna or sub antenna 400 in a mobile terminal apparatus 20, as described herein. The memory or storage 214 may include any of various memory or storage media for storing software, program instructions, data files, data structures, and the like. The software, media and program instructions may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described embodiments of the present invention.

The circuit substrate 200 includes a substrate body 205 including a battery or other power supply 250 to supply power to electronic components or elements on the circuit substrate 200. The substrate body 205 may have a plane structure. One surface of the substrate body 205 may be divided into a ground region 208 and a device region 209. Also, the substrate body 205 may be made of a dielectric in which a plurality of feeding lines may be included. In this case, the substrate body 205 may be implemented by stacking a plurality of dielectric plates. Also, both ends of each feeding line are exposed to the outside of the mobile terminal apparatus 20, and one end thereof may be connected to an external power supply. The other end of the feeding line may be exposed to the outside of the mobile terminal apparatus 20 through the device region 209. Thereby, when power from the external power supply is supplied to the end of the feeding line, the feeding line may transfer the power or signals to its other end.

The ground 240 is used to ground the circuit substrate 200. The ground 240 may be formed or disposed in the ground region 208 of the substrate body 205. Here, the ground 240 may have a plane structure, and may be formed or disposed horizontally or vertically on one surface of the substrate body 205 in the entire or a part of the ground region 208. Also, the ground 240 may be implemented as a plane structure in which various shaped grooves or holes are formed or disposed, for example.

The feeding pad 300 is formed or disposed on the circuit substrate 200, and connects the main antenna 100 to the circuit substrate 200. The main antenna 100 includes the feeding line 110 connected to the feeding pad 300.

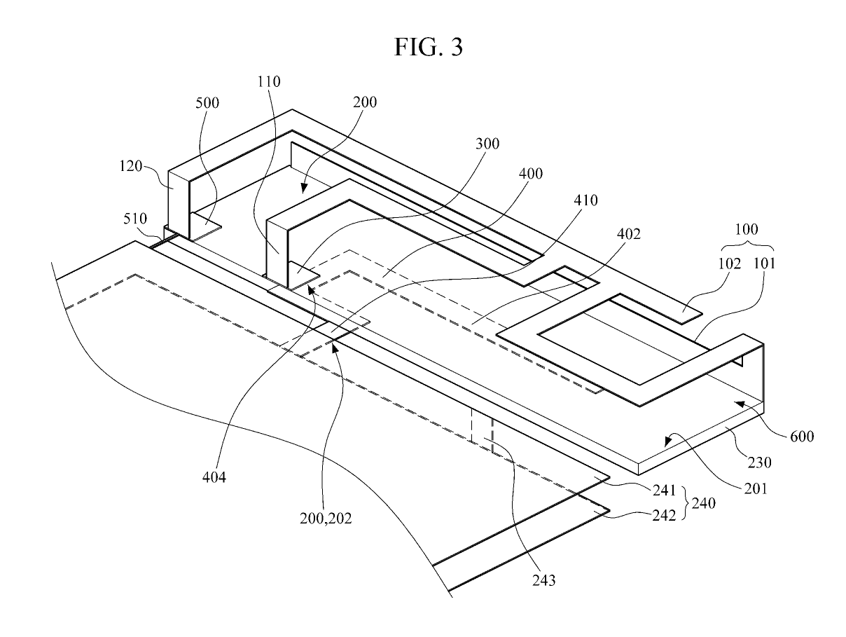

The radiating patterns 101 and 102 of the main antenna 100 contact the other end of the feeding line 110. The feeding pad 300 is formed or disposed at a contact between the radiating patterns 101 and 102 and the feeding line 110, that is, at one end of the radiating patterns 101 and 102. The radiating patterns 101 and 102 are grounded by contacting the ground 240. A ground pad 500, such as illustrated in FIG. 3, may be formed or disposed at a contact between the radiating patterns 101 and 102 and the ground 240, that is, at the other end of the radiating patterns 101 and 102.

Thereby, when power is supplied from the power supply 250 through the feeding pad 300, the radiating patterns 101 and 102 resonate in the corresponding resonance frequency band. At this time, a magnetic field may be formed or generated in the peripheral area of the radiating patterns 101 and 102.

The sub antenna 400 is spaced apart from or is disposed within a reference proximity to the feeding pad 300 in such a manner to face the feeding pad 300, and is indirectly connected to the feeding pad 300 through the electrical coupling for indirect feeding of power or signals indicated at 412, such as in FIG. 5. The sub antenna 400 is coupled with the feeding pad 300 to be fed indirectly. Also, the sub antenna 400 is connected to the ground 240 for matching with the main antenna 100. The main antenna 100 and the sub antenna 400 may support the same resonance frequency band, or different resonance frequency bands. The sub antenna 400 resonates in the resonance frequency band to receive and transmit RF signals, for example.

For example, in order to additionally support the LTE frequency band, the sub antenna 400 may transmit or receive frequency bands of 700 MHz through 900 MHz and 2.5 GHz through 2.7 GHz as resonance frequency bands. Generally, an antenna resonates when it has at least a pattern length of λ/4. For example, in order to configure a sub antenna 400 for a high band of 2.5 GHz through 2.7 GHz, a multi-band antenna having a total pattern length of λ/4 with respect to a frequency band of 2.5 GHz through 2.7 GHz may be configured with the sub antenna 400 on a second or lower surface 202 of the circuit substrate 200 from that of the main antenna 100 on a first or upper surface 201 of the circuit substrate 200 without increasing the volume of the main antenna 100 or modifying the pattern of the main antenna 100.

Meanwhile, in order to configure a sub antenna 400 for a low band of 700 MHz through 900 MHz, a sub antenna 400 having a total pattern length of λ/4 with respect to a frequency band of 700 MHz through 900 MHz may be configured on the other second or lower surface 202 of the circuit substrate 200. However, since a low frequency band has a longer wavelength than a high frequency band, the low frequency band may have a relatively great influence on the main antenna 100, which may cause the frequency band of the main antenna 100 to be shifted to the low band or a change in impedance of the main antenna 100.

In order to cause the mobile terminal apparatus 20 antenna or antennas to support a new resonance frequency, it may be typical to configure a new antenna by changing the shape of a main antenna 100. However, configuring a new antenna may increase the volume of the entire antenna inevitably. Accordingly, as described above, according to exemplary embodiments, by implementing the sub antenna 400 that may be fed indirectly through the feeding pad 300 of the main antenna 100 to cause a resonance in multiple frequency bands and in a wide frequency band range, it may be possible to support a desired frequency band as well as the frequency band of the main antenna 100, without changing the volume of the main antenna 100.

Also, the main antenna 100 and the sub antenna 400 may be ones selected from among a Planar Inverted-F Antenna (PIFA), a meander antenna, a loop antenna, an Inverted-F antenna, a wire type antenna, etc., according to a communication environment of the corresponding mobile terminal, for example.

FIG. 3 is a perspective view showing an arrangement structure of the main antenna 100, the sub antenna 400, and the circuit substrate 200 according to exemplary embodiments of the present invention.

Referring to FIG. 1 and FIG. 3, the main antenna 100 and the feeding pad 300 may be formed or disposed on the first or upper surface 201 of the circuit substrate 200, and the sub antenna 400 may be formed or disposed on the second or lower surface 202 of the circuit substrate 200. The circuit substrate 200 may be generally in the shape of a planar board, and the main antenna 100 may be directly connected to the feeding pad 300. However, since the sub antenna 400 and the feeding pad 300 may be formed or disposed on different surfaces of the circuit substrate 200, the sub antenna 400 may not directly connect to the feeding pad 300. That is, the sub antenna 400 is electrically coupled with the feeding pad 300 through the circuit substrate 200 and fed power or signals indirectly. And the feeding pad 300 may be formed or disposed to feed the main antenna 100.

However, if the thickness of the circuit substrate 200 is sufficiently thin, the sub antenna 400 may be electrically connected to the feeding pad 300 through electrical coupling to be fed power or signals indirectly. If the thickness of the circuit substrate 200 is about 0.3 mm through about 0.5 mm, for example, such indirect feeding of power or signals may be possible. Accordingly, it may be possible to implement the sub antenna 400 in the mobile terminal apparatus 20 without providing a separate feeding line (that is, a feeding pad) for supplying power or signals to the sub antenna 400, and also to receive and transmit data signals or voice signals in the at least one resonance frequency band of the sub antenna 400, as well as in the one or more resonance frequency bands of the main antenna 100.

According to exemplary embodiments, the sub antenna 400 and the main antenna 100 may be formed or disposed in substantially parallel or in facing relation to face each other in the upper and lower surfaces or first and second surfaces 201 and 202 of the circuit substrate 200. In this case, the radiating patterns 101 and 102 of the main antenna 100 may overlap the radiating pattern of the sub antenna 400, and it may be preferable or desirable that the sub antenna 400 may be applied to support an additional frequency band for a high frequency band, for example.

If the sub antenna 400 supports a high frequency band, the length of the radiating pattern of the sub antenna 400 may be reduced, so that an area where the radiating pattern 402 of the sub antenna 400 overlaps the radiating patterns 101 or 102 of the main antenna 100 also may be minimized. Accordingly, since interference of the sub antenna 400 with respect to the main antenna 100 may be minimized, the configuration described above may be preferably or desirably applied to the sub antenna 400 supporting a high frequency band. Meanwhile, if the sub antenna 400 supports a low frequency band, the radiating pattern 402 of the sub antenna 400 may be lengthened relative to a length of at least one radiating pattern 101 or 102 of the main antenna 100, so that an area where the radiating pattern of the sub antenna 400 overlaps the radiating patterns of the main antenna 100 may also be widened. Accordingly, a possibility may exist that radiation of the sub antenna 400 may cause interference of the main antenna 100 to increase.

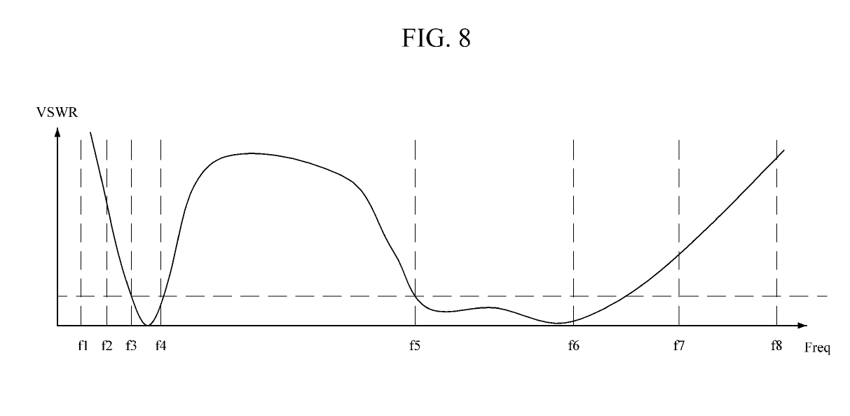

FIG. 8 is a graph showing a VSWR (Voltage Standing Wave Ratio) with respect to frequency of the main antenna 100 that supports multiple bands when no sub antenna 400 is provided as a comparison with exemplary embodiments of the present invention.

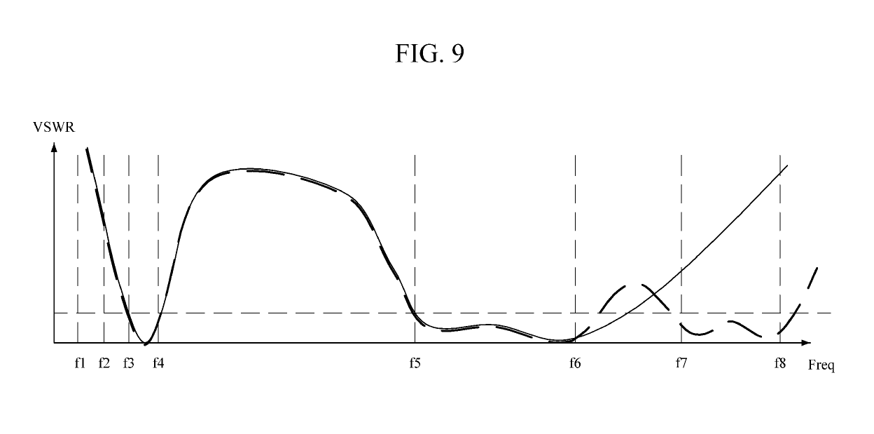

FIG. 9 is a graph showing a VSWR with respect to frequency when the sub antenna 400 supporting a high frequency band is formed or disposed on the a lower or second surface 202 of the circuit substrate 200 through an indirect feeding method according to exemplary embodiments of the present invention.

As to FIG. 9, the circuit substrate 200 may be a main printed circuit board (PCB) 210 or a sub PCB 230 (See FIG. 1, for example). Exemplary embodiments where the sub antenna 400 is formed or disposed on the rear surface of the sub PCB 230 on circuit substrate 200 are described below.

Referring to FIG. 8, when only a main antenna 100 is provided, antenna efficiency may be maintained only in a frequency band ranging from about f5 to f6, and antenna efficiency in a frequency band ranging from about f7 to f8 may be very low. Meanwhile, referring to FIG. 9, when a sub antenna 400 is provided, antenna efficiency in the frequency band from about f7 to f8, as well as in the frequency band from about f5 to f6, may be maintained. That is, referring to FIG. 1, FIG. 2, FIG. 3 and FIG. 9, by adding the sub antenna 400 as an indirect feeding antenna to the second or lower surface 202 of the circuit substrate 200, it may be possible to maintain antenna efficiency in the frequency band from about f7 to f8, as well as in the frequency band from about f5 to f6, without substantially changing or affecting the resonance frequency characteristics of the main antenna 100. Accordingly, by producing an additional resonance by the sub antenna 400, without substantially increasing the volume of the main antenna 100, a multi-band antenna for mobile terminal apparatus 20 may be implemented.

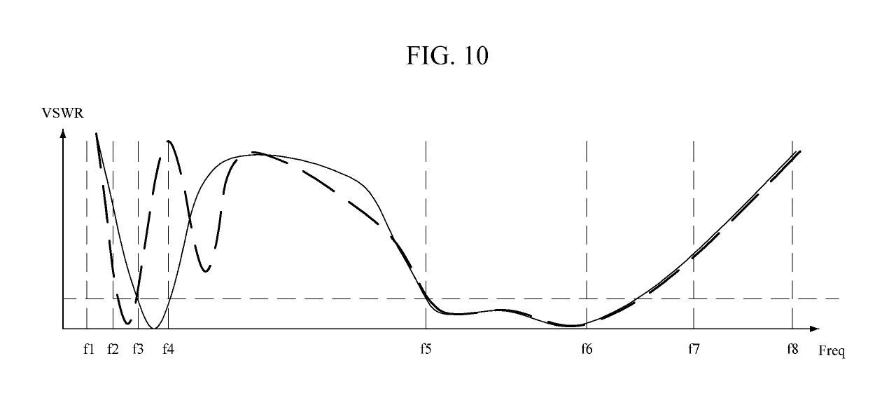

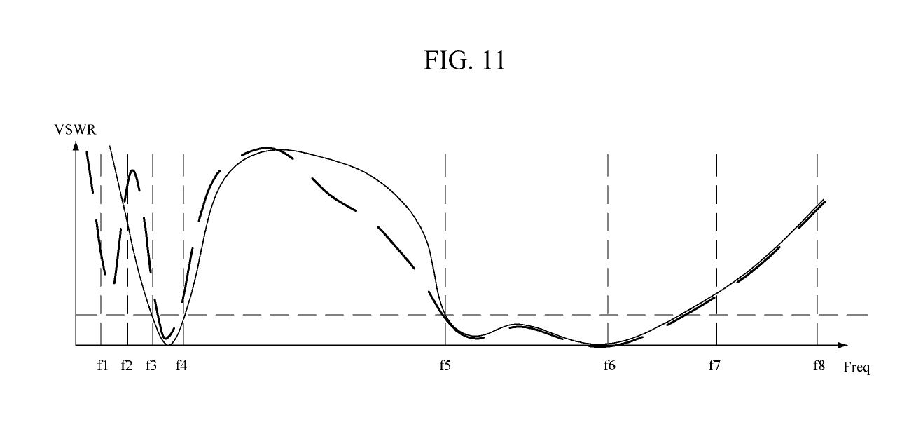

FIGS. 10 and 11 are graphs showing VSWRs with respect to frequency when the sub antenna 400 supporting a low frequency band is formed or disposed on the lower or second surface 202 of the circuit substrate 200 through the indirect feeding method according to exemplary embodiments of the present invention.

Referring to FIGS. 10 and 11, in the case of the sub antenna 400 supporting a low frequency band, if the sub antenna 400 is implemented to have a long wavelength similar to that of the main antenna 100, the sub antenna 400 may influence the low band resonance frequency of the main antenna 100 to thereby shift the resonance frequency or change the impedance of the main antenna 100. Accordingly, when the low band resonance frequency of the main antenna 100 may have to be shifted, the sub antenna 400 may be implemented to have a resonance frequency adjacent to the corresponding low band resonance frequency.

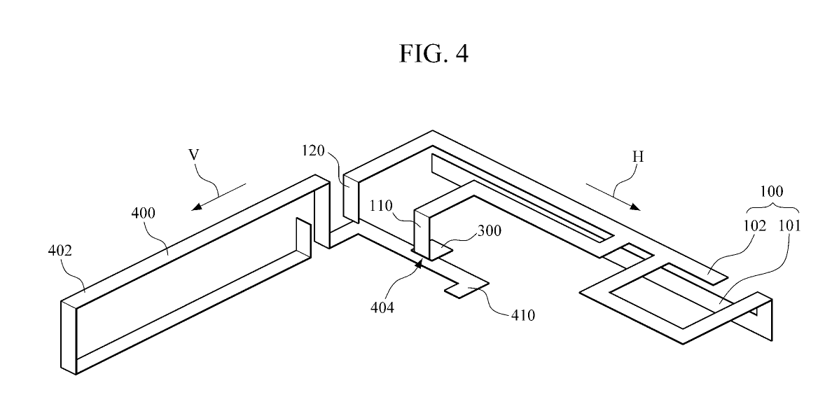

FIG. 4 is a perspective view showing an arrangement structure of the main antenna 100 and the sub antenna 400 according to exemplary embodiments of the present invention.

Referring to FIG. 4, the sub antenna 400 is formed or disposed in perpendicular or substantially perpendicular relation to the main antenna 100 so as not to be in substantially facing relation to the main antenna 100. In FIG. 4, for ease of illustration, the circuit substrate 200 is not shown. The arrangement structure shown in FIG. 4, where the sub antenna 400 does not substantially overlap the main antenna 100, and is formed or disposed substantially perpendicular thereto, may be efficiently applied to the case where the frequency band of the sub antenna 400 is a low frequency band.

However, the radiating pattern 402 of the sub antenna 400 may have to be lengthened, relative to a length of at least one radiating pattern 101 or 102 of the main antenna 100. If the sub antenna 400 may have to cover a low frequency band having a relatively long wavelength, the sub antenna 400 may therefor influence the frequency characteristics of the main antenna 100 and may have a high possibility of interfering with the transmission or reception of signals by the main antenna 100.

Accordingly, in such case, increasing a separation distance between the main antenna 100 and the sub antenna 400 may minimize interference between the main antenna 100 and the sub antenna 400. As illustrated in FIG. 4, for example, a feeding part 404 of the sub antenna 400 is formed or disposed in a relatively close spaced relation to and spaced apart from or disposed within a reference proximity to the feeding pad 300 to overlap the feeding pad 300 such that electromagnetic coupling with the feeding electrode of the feeding pad 300 occurs by coupling electrically to indirectly feed power or signals to the sub antenna 400, and the remaining part of the sub antenna 400 is formed or disposed relatively distant from the main antenna 100 in substantially perpendicular relation thereto.

And, as such, at least one radiating pattern 402 of the sub antenna 400 may be increased in length relative to one or more radiating patterns 101 or 102 of the main antenna 100. For example, as generally illustrated in FIG. 4, the main antenna 100 may be formed or disposed in a generally horizontal direction (H) in the lower portion of the corresponding mobile terminal apparatus 20, and the sub antenna 400 may be formed or disposed in a generally vertical direction (V) in the left or right side of the mobile terminal apparatus 20.

The exemplary embodiments described in relation to FIG. 4 above correspond to where a feeding part 404 of the sub antenna 400 is formed or disposed in facing or substantially facing to and spaced apart from or disposed within a reference proximity to the feeding pad 300 of the main antenna 100, and the radiating pattern 402 of the sub antenna 400 is spaced and generally extends in a direction away from the main antenna 100 in order to minimize interference of the sub antenna 400 with respect to the main antenna 100. However, the main antenna 100 and the sub antenna 400 may be arranged in any other of various directions or orientations, according to exemplary embodiments of the invention.

According to exemplary embodiments referring again to FIG. 1 and FIG. 3, the circuit substrate 200 may include the main PCB 210 formed or disposed in one side of the mobile terminal apparatus 20, the sub PCB 230 formed or disposed in the other side of the mobile terminal apparatus 20 and may have the feeding pad 300 connected to the main PCB 210 through a cable, such as RF cable 220, to receive/transmit signals from/to the main PCB 210. And the ground 240 may be spaced apart from or disposed within a reference proximity to the sub PCB 230 near one edge of the sub PCB 230 so as not to overlap the area of the main antenna 100.

Generally, the mobile terminal apparatus 20 may have the main PCB 210 in the upper portion thereof, and the sub PCB 230 and a battery or other power supply 250 in the lower portion thereof. The main antenna 100 may be positioned over the sub PCB 230, and the main PCB 210 may be connected to the feeding pad 300 of the sub PCB 230 through the RF cable 220 to transfer power or signals to the main antenna 100 and to the sub antenna 400. The main antenna 100 may be directly connected to the feeding pad 300.

The sub antenna 400 may be positioned below the sub PCB 230, and may functions as an antenna by being indirectly fed power or signals through electrical coupling with the feeding pad 300 with the sub PCB 230 positioned in between, instead of being directly connected to the feeding pad 300. At least one part of the sub antenna 400, such as feeding part 404, may be arranged in parallel or substantially parallel relation with the feeding pad 300 to face the feeding pad 300. Thereby, the sub antenna 400 may operate as an indirect feeding line of the feeding pad 300. Accordingly, through the arrangement structure of the main antenna 100 and the sub antenna 400, a multi-band antenna may be implemented according to exemplary embodiments.

The ground 240 (See FIG. 3 and FIG. 5, for example) may be generally in the shape of rectangle, and may be formed or disposed separately from the main PCB 210 or the sub PCB 230. Or, the ground 240 may be integrated into the main PCB 210 or the sub PCB 230 so that the main PCB 210 or the sub PCB 230 itself may function as the ground 240. The ground 240 may block a radiating beam from the main antenna 100 and may thereby reduce the radiating efficiency of the main antenna 100. Accordingly, in order to maximize the radiating efficiency of the main antenna 100, the ground 240 may be formed or disposed relatively close to one edge of the sub PCB 230 while being spaced apart from or disposed within a reference proximity to the sub PCB 230, such that the ground 240 does not overlap or substantially overlap the main antenna 100.

According to exemplary embodiments, the ground 240 may include a plurality of layers stacked on top of each other, wherein the individual layers may be connected to each other through a via hole or aperture 243.

The ground 240 may include a first ground 241 in the front side of the ground 240, and a second ground 242 in the rear side of the ground 240. The second ground 242 may be electrically connected to the first ground 241 through the via hole or aperture 243. The via hole or aperture 243 may electrically connect the first and second grounds 241 and 242 formed or disposed on the circuit substrate 200 to each other. The via hole or aperture 243 may be formed or disposed by making a hole or aperture with a predetermined or reference diameter at a predetermined or reference location, such as by photo etching of the circuit substrate 200 and plating the via hole or aperture 243, for example.

According to exemplary embodiments, the sub PCB 230 may have a ground pad 500 (See FIG. 3, for example) electrically connected to a part of the ground 240 (See FIG. 1, for example) through a micro strip line 510, and the main antenna 100 may be connected to the ground pad 500, such as by the ground line 120.

The ground pad 500 may be selectively electrically connected or disconnected to or from the ground 240 through the micro strip line 510. The micro strip line 510 may have a ground in the rear side, and a signal line in the front side to transfer electromagnetic signals However, the micro strip line 510 may be used to selectively electrically connect or disconnect the ground pad 500 from the ground 240, such as by the processor 212, without having any signal line or ground to selectively supply power, such as from the power supply 250, or signals to the main antenna 100, so as to selectively transmit or receive signals or electromagnetic waves at one or more first frequency bands through the main antenna 100. The micro strip line 510 may be implemented as a short, thin line with high impedance, whose length may be relatively short compared to the wavelength X in its operating frequency band, for example.

Accordingly, signals, or current, or power, such as from power supply 250, that may be supplied from the main PCB 210 may be transferred to the main antenna 100 through the feeding pad 300, and the current, or power, or signals may be circulated through the radiating patterns 101 and 102 of the main antenna 100 to reach the other end of the main antenna 100, and then return to the ground 240 through the ground pad 500, thereby forming a first transmission path or line for transmitting and receiving electromagnetic waves or signals at the one or more first frequency bands in the air.

FIG. 5 is a perspective view showing the main antenna 100, the sub antenna 400, the circuit substrate 200, and an antenna carrier unit 600 of FIG. 3 according to exemplary embodiments of the present invention.

And FIG. 6 is a cross-section view showing the main antenna 100, the sub antenna 400, and the circuit substrate 200 of FIG. 5 according to exemplary embodiments of the present invention.

Referring to FIGS. 5 and 6, in the mobile terminal apparatus 20 with the indirect feeding antenna or sub antenna 400, the antenna carrier unit 600 may be formed or disposed on or over an upper side 232 of the sub PCB 230 to fix the main antenna 100 on the sub PCB 230 of the circuit substrate 200. The antenna carrier unit 600 may be formed or disposed between the sub PCB 230 and the main antenna 100.

The antenna carrier unit 600 may be in the shape of a generally hollow rectangular parallelepiped such that it can be installed in the mobile terminal apparatus 20. The antenna carrier unit 600 may have a generally planar board structure spaced apart by a predetermined or reference distance from the sub PCB 230. And the radiating patterns 101 and 102 of the main antenna 100 may be formed or disposed on the surface of the antenna carrier unit 600 to provide antenna characteristics according to exemplary embodiments. The sub antenna 400 may be formed or disposed on the second or lower surface 202 of the circuit board 200 toward a lower side 231 of the PCB 230.

Also, the antenna carrier unit 600 may be made of a polyethylene resin including a polyolefin, an acrylonitrile butadiene styrene (ABC) resin, a polyvinyl chloride (PVC) resin, a plastic polymer such as a polycarbonate resin, etc., wherein the plastic polymer may have excellent tensile strength and surface elasticity

If the radiating patterns 101 and 102 of the main antenna 100 may be formed or disposed on the surface of the antenna carrier unit 600 made of a Polycarbonate resin by pad printing, etc., the radiating patterns 101 and 102 may be prevented from being damaged, due to the relatively excellent surface elasticity of the antenna carrier unit 600. However, a conductive ink which may be a material used for forming the radiating patterns 101 and 102 may be pressurized during the after process, which may contribute to performance maintenance of the main antenna 100.

According to exemplary embodiments, the sub antenna 400 may be connected to the second ground 242 on the rear side of the main ground 240 to be grounded.

Accordingly, current, or power, or signals supplied from the main PCB 210 may be transferred by electrical coupling to the sub antenna 400 through the feeding pad 300 through the indirect feeding, and the current, or power, or signals, may be circulated along the radiating pattern 402 of the sub antenna 400 formed or disposed, such as in a generally linear path or paths, to reach the other end of the sub antenna 400, and then return to the main ground 240 through the ground line 410 connecting the sub antenna 400 to the ground 240, thereby forming a second transmission path or line for receiving and transmitting electromagnetic waves or signals at least at one second frequency band in the air.

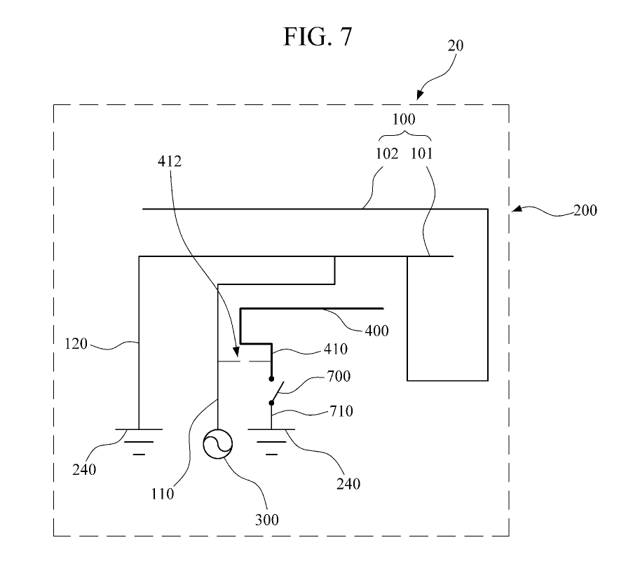

FIG. 7 is a circuit diagram illustrating a mobile terminal apparatus 20 with an indirect feeding antenna or sub antenna 400, according to exemplary embodiments of the present invention.

Referring to FIG. 7, the mobile terminal apparatus 20 with the indirect feeding antenna includes the sub antenna 400, the feeding point or feeding pad 300, and a switch or switch device 700 for selectively connecting/disconnecting the sub antenna 400 to/from the main ground 240 (See FIG. 3, for example) to selectively supply power, such as from the power supply 250, or signals indirectly through electrical coupling to the sub antenna 400 to indirectly feed power or signals indicated at 412, so as to selectively transmit or receive signals at the at least one second frequency band.

The switching device 700 may be formed or disposed between the sub antenna 400 and the main ground 240 to selectively connect/disconnect the sub antenna 400 to/from the main ground 240. Since the switch or switching device 700 may be connected to the main ground 240 through a ground line 710, the switching device 700 may electrically selectively connect/disconnect the sub antenna 400 to/from the main ground 240. The switching device 700 may be a RF switch device, such as a diode, a transistor, a Field Effect Transistor (FET), a Micro Electro Mechanical Systems (MEMS), and a Complementary Metal Oxide Semiconductor (CMOS) switch device, for example which may perform a switching function using current and voltages, such as from power supply 250 of FIG. 1, for example.

By selectively turning on/off the switching device 700, such as by the processor 212, to selectively connect the sub antenna 400 to the main ground 240, it may be possible to improve the quality of wireless communication adaptively according to a wireless communication environment including the resonance frequency band of each of the main antenna 100 and the sub antenna 400.

Therefore, in the mobile terminal apparatus with the indirect feeding antenna or sub antenna according to exemplary embodiments described above, by indirectly feeding a sub antenna through electrical coupling with a feeding pad of a main antenna, a resonance may be caused in multiple frequency bands and a wide frequency band range so as to additionally support a desired frequency band, as well as the frequency band of the main antenna and a size of the main antenna may not be increased.

Also, since the sub antenna may be formed or disposed in an existing space for the main antenna, it may be unnecessary to increase a size of the mobile terminal to accommodate the sub antenna.

In addition, since there may be substantially no interference between the sub antenna and the main antenna, the sub antenna may be selectively used while maintaining the antenna performance of the main antenna, which may thereby increase antenna efficiency according to the characteristics of a given frequency band according to exemplary embodiments.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A mobile terminal apparatus to perform wireless communication, the apparatus comprising:
a main antenna to transmit or receive signals at one or more first frequency bands;
a sub antenna to transmit or receive signals at least at one second frequency band; and
a feeding pad connected to the main antenna to directly feed signals to the main antenna to transmit or receive signals at the one or more first frequency bands, the feeding pad being disposed within a reference proximity to and electrically coupled to the sub antenna to indirectly feed signals to the sub antenna to transmit or receive signals in the at least one second frequency band.

2. The mobile terminal apparatus of claim 1, further comprising:
a circuit substrate, wherein the main antenna and the feeding pad are disposed on a first surface of the circuit substrate and the sub antenna is disposed on a second surface of the circuit substrate; and
s wherein the feeding pad is electrically coupled to the second antenna though the circuit substrate to indirectly feed signals to the second antenna.

3. The mobile terminal apparatus of claim 2, wherein the at least one second frequency band is within the one or more first frequency bands or is within other than the one or more first frequency bands.

4. The mobile terminal apparatus of claim 2, wherein the main antenna comprises a feeding line to connect the main antenna to the feeding pad to directly feed signals to the main antennal.

5. The mobile terminal apparatus of claim 2, further comprising:
a ground disposed on the circuit substrate to ground the main antenna and the sub antenna;
a first ground pad to connect the main antenna to the ground; and
a second ground pad to connect the sub antenna to the ground.

6. The mobile terminal apparatus of claim 5, further comprising:
a first transmission path comprising the feeding pad, the main antenna, the first ground pad and the ground to transmit and receive electromagnetic waves corresponding to signals of the one or more first frequency bands when signals are selectively fed to the feeding pad; and
a second transmission path comprising the feeding pad electrically coupled to the sub antenna, the sub antenna, the second ground pad and the ground to transmit and receive electromagnetic waves corresponding to signals of the at least one second frequency band when signals are selectively fed to the feeding pad and indirectly to the sub antenna.

7. The mobile terminal apparatus of claim 2, wherein the main antenna on the first surface of the circuit substrate and the sub antenna on the second surface of the circuit substrate are disposed in facing relation to each other.

8. The mobile terminal apparatus of claim 2, wherein
at least one radiating pattern of the main antenna overlaps a radiating pattern of the sub antenna, and
the radiating pattern of the sub antenna is of a reduced length relative to at least one radiating pattern of the main antenna.

9. The mobile terminal apparatus of claim 1, wherein the main antenna and the sub antenna are disposed in perpendicular relation to each other.

10. The mobile terminal apparatus of claim 9, wherein a radiating pattern of the sub antenna is of an increased length relative to at least one radiating pattern of the main antenna.

11. The mobile terminal apparatus of claim 1, wherein a length of a radiating pattern of the main antenna or the sub antenna corresponding to a low frequency band is of an increased length relative to a radiating pattern of the main antenna or the sub antenna corresponding to a high frequency band.

12. The communication terminal apparatus of claim 1, wherein
the main antenna comprises a plurality of radiating patterns to resonate at corresponding ones of a plurality of the first frequency bands, and
the second antenna comprises at least one radiating pattern to resonate at a corresponding one of the at least one second frequency band.

13. The mobile terminal apparatus of claim 1, further comprising:
a circuit substrate; and
an antenna carrier unit disposed over a surface of the circuit substrate, wherein one or more radiating patterns corresponding to the one or more first frequency bands of the main antenna are disposed on the antenna carrier unit.

14. The mobile terminal apparatus of claim 13, wherein the sub antenna is disposed on a lower surface of the circuit substrate than a surface of the circuit substrate over which the antenna carrier unit is disposed.

15. The mobile terminal apparatus of claim 1, further comprising:
a circuit substrate, wherein the main antenna, the feeding pad and the sub-antenna are disposed on the circuit substrate;
a ground disposed on the circuit substrate to ground the main antenna and the sub antenna; and
a switch disposed on the circuit substrate to selectively connect or disconnect the sub antenna from the ground to selectively transmit or receive signals at the least at one second frequency band.

16. The mobile terminal apparatus of claim 1, wherein the main antenna and the sub antenna comprise one or more of a Planar Inverted-F Antenna (PIFA), a meander antenna, a loop antenna, an Inverted F-antenna, or a wire type antenna.

17. The mobile terminal apparatus of claim 1, wherein the one or more first frequency bands or the at least one second frequency band comprise frequency bands of one or more of 700 MHz to 960 MHz, 1,700 MHz to 2,100 MHz, or 2.5 GHz to 2.7 GHz.

18. A method for performing wireless communication in a mobile terminal apparatus, the method comprising:
feeding signals at one or more first frequency bands directly by a feeding pad to a main antenna to transmit or receive signals at the one or more first frequency bands; and
feeding signals at least at one second frequency band indirectly by the feeding pad to a sub antenna, by electrically coupling the feeding pad to the sub antenna disposed within a reference proximity to the feeding pad, to transmit or receive signals in the at least one second frequency band.

19. The method of claim 18, wherein:
at least one radiating pattern of the main antenna overlaps a radiating pattern of the sub antenna, and
a radiating pattern of the sub antenna is of a reduced length relative to a length of at least one radiating pattern of the main antenna.

20. The method of 19, wherein the main antenna is disposed in facing relation to the sub antenna.

21. The method of claim 18, wherein at least one radiating pattern of the main antenna in disposed in facing relation to at least one radiating pattern of the sub antenna.

22. The method of claim 18, wherein the main antenna is disposed in substantially perpendicular relation to the sub antenna.

23. The method of claim 22, wherein a radiating pattern of the sub antenna is of an increased length relative to a length of at least one radiating pattern of the main antenna.

24. The method of claim 18, further comprising:
forming a first transmission path comprising the feeding pad, the main antenna, and a ground to transmit and receive electromagnetic waves corresponding to signals of the one or more first frequency bands; and
forming a second transmission path comprising the feeding pad electrically coupled to the sub antenna, the sub antenna and the ground to transmit and receive electromagnetic waves corresponding to signals of the at least one second frequency band.

25. The method of claim 18, wherein an additional resonance by the sub antenna is produced when signals are indirectly fed to the sub antenna without changing a resonance frequency band of the main antenna.

26. A method for performing wireless communication in a mobile terminal apparatus, the method comprising:
selectively feeding signals at one or more first frequency bands directly by a feeding pad to a main antenna to selectively transmit or receive signals at the one or more first frequency bands; and
selectively feeding signals at least at one second frequency band indirectly by the feeding pad to a sub antenna, by electrically coupling the feeding pad to the sub antenna disposed within a reference proximity to the feeding pad, to selectively transmit or receive signals in the at least one second frequency band.

27. The method of claim 26, further comprising:
selectively connecting or disconnecting the sub antenna from a ground to selectively transmit or receive signals at the least at one second frequency band.

28. The method of claim 27, further comprising:
selectively connecting or disconnecting the main antenna from the ground to selectively transmit or receive signals at the one or more first frequency bands.
